(19) United States
(12) Patent Application Publication
(10) Pub. No.: US 2005/0154590 A1
(43) Pub. Date: Jul. 14, 2005

(54) Method for assisting the grading and recording of educational tasks in an electronic gradebook using voice recognition

(76) Inventors: Mark Allan Coffey, Boulder, CO (US); Steve Anderson, Broomfield, CO (US); Nicholas Bernstein, Boulder, CO (US); Justin Armstrong, Boulder, CO (US)

Correspondence Address: WET NOSE, LLC, 5385 OLDE STAGE ROAD, BOULDER, CO, 80302, US

(21) Appl. No.: 10/753,687

(22) Filed: Jan. 9, 2004

(51) Int. Cl. G10L 11/00

(52) U.S. Cl. 704/270

(57) ABSTRACT

The invention consists of a method for assisting educators in the process of evaluating, grading and recording any task-based assignment utilizing a voice recognition front-end.

### BACKGROUND OF INVENTION

Many teachers put in considerable overtime, both on the job and at home, in order to keep up with the demands of education. One of these demands is the correcting, grading and recording of homework, exams and other assigned tasks. This invention seeks to reduce the amount of time and work incurred by educators in evaluating students by using a voice-recognition front end to an electronic gradebook.

### SUMMARY OF INVENTION

The invention consists of a method for assisting educators in the process of evaluating, grading and recording any task-based assignment utilizing a voice recognition front-end.

### DETAILED DESCRIPTION

The invention consists of a method for assisting educators in the process of evaluating, grading and recording any task-based assignment, including but not limited to homework, exams, attendance and projects. The method utilizes a voice recognition front-end to record evaluative details that are naturally spoken during the review process and then uses a template to aggregate the recorded details into useful data. This data is in turn automatically entered into a computer-based gradebook or similar spreadsheet-based application.

The invention also provides for storing the evaluative information on a per-student, per-assignment basis. Conventional gradebooks and similar programs record only the overall grade of an assignment. This method retains information about individual tasks within an assignment and allows for detailed analysis of class-wide trends on individual questions or assignments.

An example of the method includes grading a homework assignment. A teacher enables the voice recognition front-end for an electronic gradebook and then begins speaking as he or she grades the homework: “John Doe . . . number 3 wrong . . . number 6 wrong . . . number 6 right . . . number 10 wrong . . . total?”

The voice interface recognizes the input, tallies incorrect answers and consults a template for the homework assignment. After comparing the input to the template, the interface can establish that the student scored 80% and automatically record that data in the appropriate entry of an electronic gradebook. The voice interface can also provide an audio version of the student's score that the teacher can write on the assignment. The method thus eliminates the need for the teacher to tally, grade or record when finished with grading.

After grading the assignment, the teacher is then informed by the gradebook that 44% of the students missed question #3. Upon review, the teacher then decides that the material which question #3 was meant to test needs further attention in class, or may choose to rescore the assignment with less emphasis placed on the poorly-worded question.

1. A method of assisting the low-level entry of information related to educational assignments into an electronic administrative utility, said method comprising the steps of:
a) receiving elementary information about the response to or correctness of a response to a given question in an assignment via keyboard and mouse;
b) recording the response in a data structure;
c) grading the assignment from a template of acceptable responses;
d) tallying the completed assignment; and
e) recording the grade in a data structure.

2. The method of claim 1 further comprising the step of receiving response information via a spoken grammar into a microphone and using speech recognition algorithms to parse said response into usable data.

3. The method of claim 2 further comprising the step of providing audible feedback when voice input is not understood or when an indication of successful data entry is required.

4. The method of claim 3 further comprising the step of providing visual feedback confirming the input of said response or requesting clarification if data entry was not successful.

5. The method of claim 1 further comprising the step of receiving response information via an optical scanner used to scan the completed assignment and using optical character recognition to parse said responses.

6. The method of claim 5 further comprising the step of providing visual feedback confirming the input of all responses or requesting clarification if data entry was not successful.

7. A method for the analysis of the low-level data of claim 1, said method comprising the steps of:
a) receiving an evaluative data point comprising a response or evaluation of said response;
b) an optional mapping or filter of a data point against predefined criteria, said criteria possibly including, but not limited to, an answer key template or educational standards;
c) a report generated to indicate trends or anomalies of interest in the data set, said report possibly including, but not limited to:
i) a list of possibly ambiguous questions or questions that were not adequately taught prior to the assignment;
ii) a list of students who are possibly cheating, generated by a temporal point-to-point correlation study done across the set of students;
iii) standards tracking and fulfillment, generated by cross-checking the standards tested by individual questions against the total set of required educational standards; and
iv) a report of simple assignment statistics, including average score, standard deviation and bell curves.
